(19) United States
(12) Patent Application Publication
(10) Pub. No.: US 2009/0300279 A1
(43) Pub. Date: Dec. 3, 2009

(54) Signature Based Method for Sending Packets to Remote Systems

(75) Inventors: David L. Helsley, Glastonbury, CT (US); Lawrence A. Lee, Chino Hills, CA (US); Osvaldo A. Ridner, Folsom, CA (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 12/128,277

(22) Filed: May 28, 2008

(51) Int. Cl. G06F 12/00

(52) U.S. Cl. 711/111; 711/E12.001

(57) ABSTRACT

A method comprises generating a plurality of signatures, wherein each complex signature corresponds to and identifies a respective one of a plurality of virtual tape complexes, and wherein each virtual tape complex comprises one or more subsystems and a control store linked to the one or more subsystems. For each virtual tape complex, a copy of the corresponding signature is stored in the control store corresponding to the virtual tape complex.

### TECHNICAL FIELD

The present disclosure relates generally to data storage and communication, and more specifically to a signature based system and method for sending packets to remote systems.

### BACKGROUND

A tape drive is a data storage device that reads and writes data stored on a magnetic tape. Tape storage has traditionally been relied upon for archival data storage, particularly in mainframe environments. Although tape storage provides long archival stability, tape drives can take up a lot of space and be very expensive to purchase and maintain. Furthermore, tape drives only allow for sequential access of data. This means that a tape drive must spend a considerable amount of time winding reels, resulting in slow access times. The sequential access nature of tape drives may also lead to under-utilization of space on the tape reels. Recently, virtual tape systems have been introduced. When used in combination with traditional tape storage devices, these virtual tape systems may provide more affordable and efficient data storage.

### SUMMARY OF EXAMPLE EMBODIMENTS

The present disclosure is directed to a system and method for sending packets to remote systems. The teachings of the present disclosure may allow for more efficient and affordable storage and data backup.

In accordance with a particular embodiment of the present disclosure, a method comprises generating a plurality of signatures, wherein each complex signature corresponds to and identifies a respective one of a plurality of virtual tape complexes, and wherein each virtual tape complex comprises one or more subsystems and a control store linked to the one or more subsystems. For each virtual tape complex, a copy of the corresponding signature is stored in the control store corresponding to the virtual tape complex. More specifically, communication between two virtual tape complexes may be established. Data and a desired destination signature are sent, from a first subsystem located on a first virtual tape complex, to a temporary data store located on the first virtual tape complex, wherein the desired destination signature corresponds to a second virtual tape complex. The data is copied to the temporary data store and the second virtual tape complex is monitored for an active subsystem. When an active subsystem is found, the data is sent from the temporary data store to the active subsystem.

In accordance with another aspect of the present invention, a system comprises a plurality of virtual tape complexes, wherein each virtual tape complex comprises one or more subsystems and a control store linked to the one or more subsystems. For each virtual tape complex, a processor is operable to generate a signature, wherein the signature corresponds to and identifies the respective virtual tape complex.

In accordance with another aspect of the present invention, logic encoded in a computer readable medium is operable, when executed on a processor, to generate a plurality of signatures, wherein each signature corresponds to and identifies a respective one of a plurality of virtual tape complexes, and wherein each virtual tape complex comprises one or more subsystems and a control store linked to the one or more subsystems. For each virtual tape complex, the logic is further operable to store a copy of the corresponding signature in the control store corresponding to the virtual tape complex.

Technical advantages of particular embodiments of the present disclosure include a method comprising generating and storing a signature in a control store located on a virtual tape complex. This may allow subsystems to be renamed or added within any virtual tape complex and still be located by the signature associated with the virtual tape complex.

Further technical advantages of particular embodiments include establishing communication between two virtual tape complexes using a temporary data store. This may allow asynchronous communication between virtual tape complexes. This may allow data packets to be sent from one subsystem to another complex, even when the subsystems on the desired destination complex are inactive.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and for further features and advantages thereof, reference is now made to the following description taken in conjunction with the accompanying drawings, in which:

FIG. 1 is a schematic illustration of a virtual tape network in accordance with particular embodiments of the present disclosure;

FIG. 2 is a schematic illustration of a control store located on a virtual tape complex in accordance with particular embodiments of the present disclosure; and

FIG. 3 is a flow diagram illustrating a method of sending data to remote systems in accordance with particular embodiments of the present disclosure.

### DETAILED DESCRIPTION

Tape as a storage medium for mainframes is extremely important. The tape is used for archival purposes and commonly as a primary storage medium. Often, tape is used even for short term storage where the file size from day to day varies significantly such that it is difficult to effectively allocate direct access storage device (DASD) space for the file. Vast and expensive tape management subsystems have been developed which prevent tapes once written from being overwritten until otherwise authorized.

Commonly, tape cartridges are available in 400 MB, 800 MB, and more recently, 10 GB and 20 GB sizes. The tape capacity is expected to continue to increase. Unfortunately, a typical application seeking access to a tape in which to store its data set is not likely to fill up an entire tape. Thus, if, for example, the data set is 100 MB and the tape size is 400 MB, the application will gain access to the tape, store its data set, close the tape, and the tape will remain underutilized for the period that that data must be archived. This has resulted in significant under-utilization of tape cartridges such that, on average, cartridges may be only 25% utilized. While it is, of course, possible in a mainframe environment to put multiple data sets having different formats on a tape, it is not generally done because it requires an agreement between the potential users to allocate the tape capacity. As the number of applications seeking access to the tape increases, the management overhead becomes prohibitive.

This problem led to the development of a software stacking product to try to improve capacity utilization. Generally, after a plurality of applications have placed their data on a plurality of different tapes, the software stacking products load the tapes and move data from one tape to another. This uses mainframe resources and also creates the potential problem that the application may remember where it stored the data, e.g. the particular cartridge number, resulting in recovery errors. Moreover, if a single application wants two data sets simultaneously stacked on the same tape, failure may result. Also, even if two applications are searching data sets from the same tape, one must wait until the first completes its access. This may significantly negatively impact the mainframes' ability to do batch processing. As a result of these logistical and overhead problems, the software stacking products have largely failed to satisfy the capacity issues existing in the industry.

Typical tape systems are leased because turnover in technology may make purchasing them economically impractical. One problem with existing hardware tape drives is that they require a large amount of physical space and tend to be quite expensive. For example, if a user wants 64 drives (to permit up to 64 applications to simultaneously write to tape), significant amounts of physical area must be allocated to those drives. In addition to the floor space, the lease for such systems usually includes a maintenance charge on a per drive basis, including a drive automation, that may be on the order of $1000 per month. Thus, in the 64 drive example, $64,000 a month is spent purely in maintenance charges for the physical drives. The underutilization problem further increases costs as a large number of cartridges are required to hold less data.

More recently, virtual tape systems have come into use. These systems may use a combination of DASD and tape drives. Thus, when an application sends data to the virtual tapes, the data set may be loaded into the DASD and then migrated to the tape later. The systems may permit emulation of multiple tape drives with a limited number of physical drives. These virtual tape systems are increasingly relied upon in conjunction with traditional tape drives to provide more affordable and efficient data storage. The use of direct-access storage in these virtual tape complexes may allow more efficient utilization of sequential access tape drives. Additionally, virtual tape complexes may allow for data sharing and communication between multiple complexes across a communication network. During peer to peer communication between complexes, a method of uniquely identifying other virtual tape complexes may be desirable.

In accordance with the teachings of the present disclosure, a plurality of virtual tape complexes may be connected over a communications network. An object of the present disclosure is to provide a signature-based method for sending data to remote virtual tape complexes.

In accordance with a particular embodiment of the present disclosure, a method comprises generating a plurality of signatures, wherein each signature corresponds to and identifies a respective one of a plurality of virtual tape complexes, and wherein each virtual tape complex comprises one or more subsystems and a control store linked to the one or more subsystems. As used throughout this disclosure, “each” means every one of at least a subset of the identified items. For each virtual tape complex, a copy of the corresponding signature is stored in the control store corresponding to the virtual tape complex.

According to particular embodiments, communication between two virtual tape complexes may be established. Data and a desired destination signature are sent, from a first subsystem located on a first virtual tape complex, to a temporary data store located on the first virtual tape complex, wherein the desired destination signature corresponds to a second virtual tape complex. The data is copied to the temporary data store and the second virtual tape complex is monitored for an active subsystem. When an active subsystem is found, the data is sent from the temporary data store to the active subsystem.

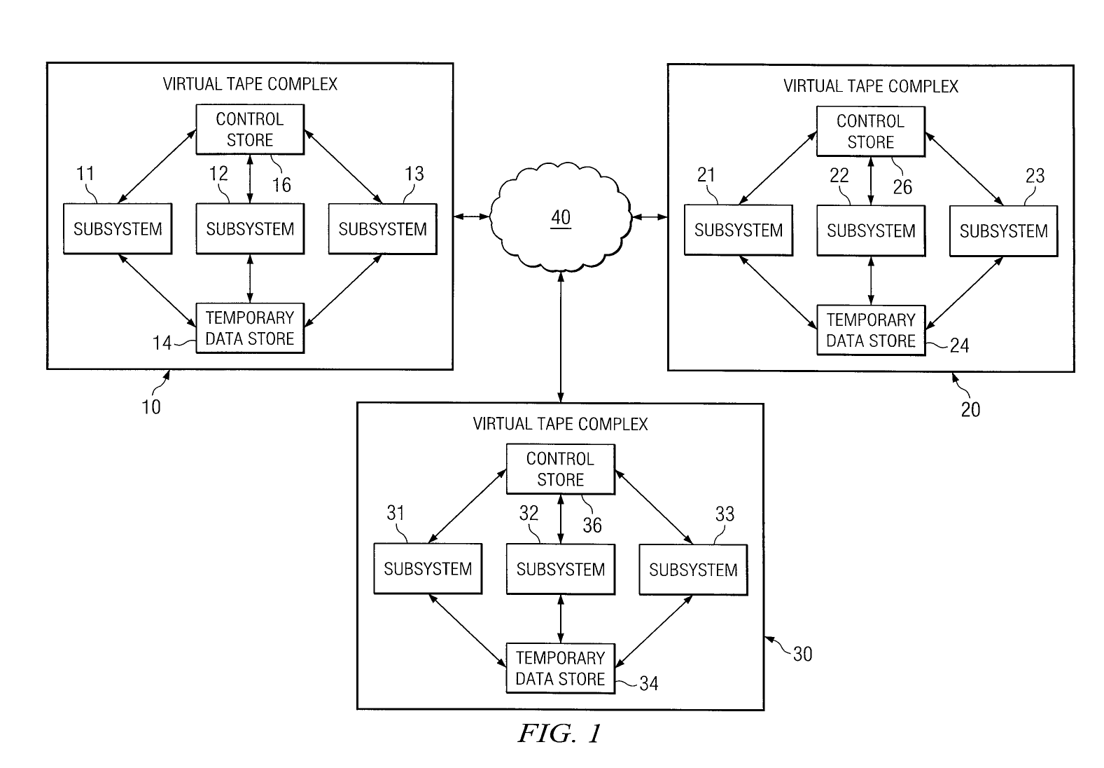

FIG. 1 illustrates a schematic view of a virtual tape network according to particular embodiments of the present disclosure. According to the illustrated embodiment, virtual tape network comprises virtual tape complexes 10, 20, and 30 connected using communication network 40. In the illustrated embodiment, three virtual tape complexes are pictured. However, in alternative embodiments, any number of virtual tape complexes could be employed and connected using communication network 40.

Virtual tape complex 10 comprises subsystems 11, 12, and 13. Although three subsystems are illustrated, fewer or more subsystems may be located on virtual tape complex 10. Virtual tape complex further comprises temporary data store 14 and control store 16. Temporary data store 14 is connected to each of the subsystems located on virtual tape complex 10. Although the illustrated embodiment discloses one temporary data store 14, in alternative embodiments multiple temporary data stores may be used for a given virtual tape complex 10. For instance, there may be a unique temporary data store for connection with each of subsystems 11, 12, and 13. Control store 16 is connected to each of the subsystems located on virtual tape complex 10. Although the illustrated embodiment discloses one control store 16, in alternative embodiments multiple control stores may be used for a given virtual tape complex. For instance, there may be a unique control store for connection with each of subsystems 11, 12, and 13.

Virtual tape complex 20 comprises subsystems 21, 22, and 23. Although three subsystems are illustrated, fewer or more subsystems may be located on virtual tape complex 20. Virtual tape complex further comprises temporary data store 24 and control store 26. Temporary data store 24 is connected to each of the subsystems located on virtual tape complex 20. Although the illustrated embodiment discloses one temporary data store 24, in alternative embodiments multiple temporary data stores may be used for a given virtual tape complex 20. For instance, there may be a unique temporary data store for connection with each of subsystems 21, 22, and 23. Control store 26 is connected to each of the subsystems located on virtual tape complex 20. Although the illustrated embodiment discloses one control store 26, in alternative embodiments multiple control stores may be used for a given virtual tape complex. For instance, there may be a unique control store for connection with each of subsystems 21, 22, and 23.

Virtual tape complex 30 comprises subsystems 31, 32, and 33. Although three subsystems are illustrated, fewer or more subsystems may be located on virtual tape complex 30. Virtual tape complex further comprises temporary data store 34 and control store 36. Temporary data store 34 is connected to each of the subsystems located on virtual tape complex 30. Although the illustrated embodiment discloses one temporary data store 34, in alternative embodiments multiple temporary data stores may be used for a given virtual tape complex 30. For instance, there may be a unique temporary data store for connection with each of subsystems 31, 32, and 33. Control store 36 is connected to each of the subsystems located on virtual tape complex 30. Although the illustrated embodiment discloses one control store 36, in alternative embodiments multiple control stores may be used for a given virtual tape complex. For instance, there may be a unique control store for connection with each of subsystems 31, 32, and 33.

Although much of the remaining detailed description will be given with particular reference to virtual tape complex 10 and its specific elements, it should be understood that this is for illustrative purposes and is not intended to be limited to virtual tape complex 10. For instance, descriptions of subsystems, controls stores, and data stores may apply to analogous elements of virtual tape complexes 20 and 30.

Subsystem 11 may be made up of control files containing virtual volumes. These virtual volumes may take various forms. In particular embodiments, they may comprise a DASD cache. This may allow for easier storage of information. Additionally, the virtual volumes may be shared and sent between subsystems on different virtual tape complexes. After a certain threshold time, the virtual volumes may be written to physical tape. This threshold time may be a predetermined value, or it may be something that a user can selectively change. Additionally, algorithms may be used to determine when and how the virtual volumes are written to the actual tape. This may allow for efficient tape-stacking, reducing the under-utilization problems typically associated with tape drives. These steps may be accomplished through the use of any suitable hardware, and are not limited to the use of proprietary hardware.

Virtual volumes may be shared between multiple complexes. This may be particularly useful where a limited number of actual tape drives are utilized. For instance, virtual tape complex 10 may have access to an actual tape drive, while, virtual tape complex 20 may not. In this case, subsystem 21 may send copies of data stored on virtual volumes to virtual tape complex 10, where it may then be written to actual tape. Sharing between complexes may also provide additional failover support for data recovery purposes.

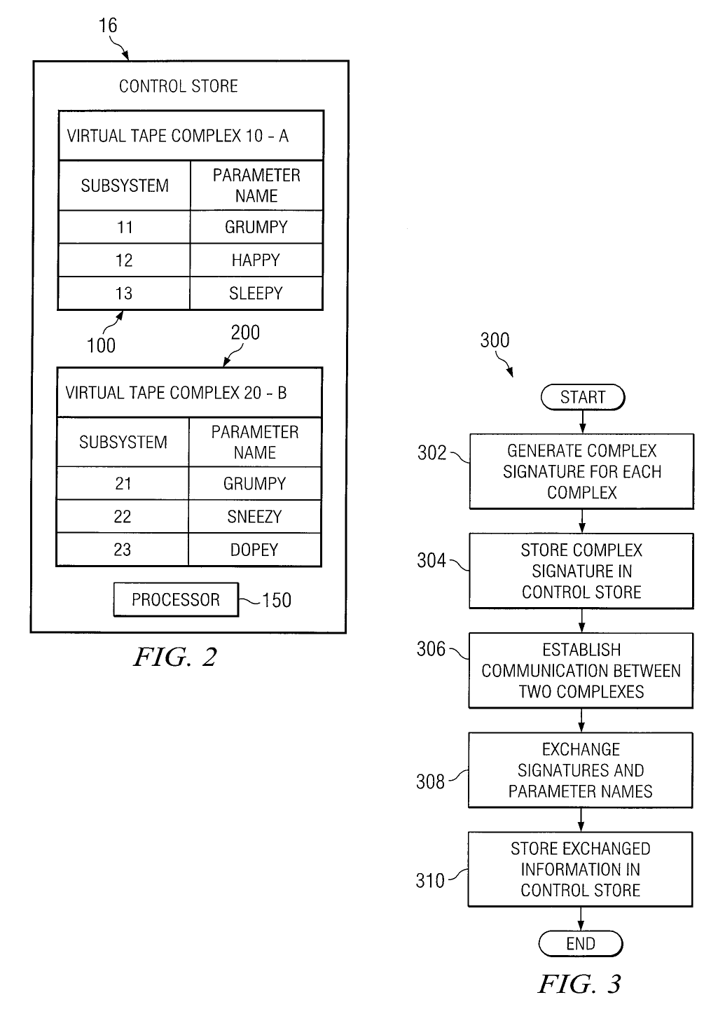

FIG. 2 is a schematic illustration of a control store 16 located on a virtual tape complex 10 in accordance with particular embodiments of the present disclosure. Control store 16 may comprise any combination of hardware and software operable to generate and store information about complexes and subsystems. In the illustrated embodiment, control store 16 comprises data tables 100 and 200 and processor 150. Although only two tables are illustrated, any number of tables may be included, depending on the storage capabilities of control store 16.

According to the teachings of the present disclosure, processor 150 may generate a signature for virtual tape complex 10. This signature identifies the virtual tape complex. Signatures may also be generated, using analogous processors, for complexes 20 and 30. The signatures may comprise a 4 byte CRC32 hash of important information. This information may include, but is not limited to control files and other control information. The signature is intended to uniquely identify a virtual tape complex, and once created, may not be altered. In particular embodiments, each complex may have a distinct signature. In alternative embodiments, multiple subsystems may share the same complex signature.

After the signatures are generated, they are stored in the control store located on the virtual tape complex that the signature corresponds to. Information regarding these signatures and relationships is stored in the control store. For instance, in the illustrated example, control store 16 is pictured. Control store 16 is located on virtual tape complex 10 and linked to subsystems 11, 12, and 13. Therefore, control store 16 will store information about the signatures and relationships of virtual tape complex 10 and subsystems 11, 12, and 13.

In the illustrated embodiment, signature “A” is generated to identify virtual tape complex 10. Therefore, control store 16 will show that signature “A” identifies virtual tape complex 10 and any subsystems that make up virtual tape complex 10. Therefore, control store 16 will contain information that subsystems 11, 12, and 13 are located on virtual tape complex 10. Although the illustrated embodiment shows this information presented in tabular format, it may be stored in any suitable format for relational data storage.

During use of the present system, subsystems may be added or removed from a virtual tape complex. For example, a user, such as a network administrator, may add a subsystem to virtual tape complex 10. In this instance, control store 16 will be updated to include information about the new subsystem, including the fact that it is located on virtual tape complex 10. This process may be performed automatically upon addition of a new subsystem. In alternative embodiments, this addition of information may be performed manually by a user or network administrator.

During use of the present system, parameter names may also be created for the various subsystems. These parameter names may take any form, including TCP/IP address, domain name, or port. They may most often come in the form of user-friendly “English” names. For instance, a user may provide parameter names of Grumpy, Happy, Sleepy, etc. for a set of subsystems. These parameter names may be user-defined, in an attempt to make subsystems more easily identifiable to a user. Information about these parameter names will also be stored in control stores. In table 100 of control store 16, for example, parameter name “Grumpy” is stored as identifying subsystem 11, parameter name “Happy” is stored as identifying subsystem 12, and parameter name “Sleepy” is stored as identifying subsystem 13.

Although parameter names may make elements more easily identifiable by a given user, they may be unique to a user or operator of a given virtual tape complex. Furthermore, parameter names may also be edited or altered by a user. Therefore, the elements may not always be easily identifiable by the virtual tape complexes. Thus, once signatures are generated, they do not change. This allows a user to change the parameter name for a subsystem, but the signature identifying the associated virtual tape complex will remain the same, allowing the subsystem to be located by signature.

Another benefit of using a virtual tape network is the ability of virtual tape complexes to engage in peer to peer communication. As shown in FIG. 1, this communication may be accomplished using communication network 40. More specifically, when two virtual tape complexes engage in communication, they may exchange information. This information may include, but is not limited to, the signature corresponding to the virtual tape complex, the subsystems located on the virtual tape complex, the parameter names of the subsystems, the content of virtual volumes, and the scratch status of virtual volumes. This information regarding a second virtual tape complex may then be stored in the control store of the first virtual tape complex.

For instance, in the embodiment illustrated by FIG. 2, virtual tape complex 10 has engaged in peer to peer communication with virtual tape complex 20. During this communication, the two complexes exchange information. While control store 16 already includes information in table 100 about the elements on virtual tape complex 10, the new information regarding virtual tape complex 20 may now also be stored in control store 16. Therefore, in the illustrated embodiment, control store 16 stores information in table 200 showing that virtual tape complex 20 is made up of subsystems 21, 22, and 23. Furthermore, signature “B” identifies virtual tape complex 20. Control store 16 may also store information regarding parameter names, if any exist. In the illustrated embodiment, parameter name “Grumpy” corresponds to subsystem 21, parameter name “Sneezy” corresponds to subsystem 22, and parameter name “Dopey” corresponds to subsystem 23. The illustrated embodiment helps to show the importance of signatures. Therefore, subsystems 11 and 21 have the same parameter names but are located on different virtual tape complexes. A third virtual tape complex, such as complex 30, may desire to send data to subsystem 11. If virtual tape complex were only relying on parameter names for identifying the intended recipient, it would be unable to distinguish between subsystems 11 and 21. However, because the virtual tape complexes have unique identifying signatures, complex 30 may correctly identify subsystem 11 because it resides on virtual tape complex 10.

This information may allow virtual tape complexes to more effectively communicate with one another in the future. For instance, if the parameter names of subsystems located on virtual tape complex 20 are changed, virtual tape complex 10 may still seek out an intended subsystem based on the signature of its associated virtual tape complex. For example, after information has been exchanged and table 200 is populated with the information illustrated in FIG. 2, a user of virtual tape complex may decide to change the parameter names of subsystems 21, 22, and 23 to “Homer,” “Marge,” and “Bart,” respectively. Without signatures, virtual tape complex 10 would be unable to communicate with the subsystems of virtual tape complex 20, as it would be attempting to make contact based on out-of-date parameter names. However, since the signatures do not change, virtual tape complex 10 will be able to maintain communications, despite parameter name changes to subsystems.

The information stored in control store 16 may also allow for asynchronous communication between two virtual tape complexes. For instance, oftentimes a first subsystem on a first virtual tape complex will attempt to send data to a second virtual tape complex. According to particular embodiments, the desired destination may be a specific subsystem. However, for certain types of data, these affinity issues may not exist, and the desired destination may be any subsystem located on a particular virtual tape complex. However, in some instances, this may occur when subsystems on the desired destination complex are inactive or offline. Traditionally, this would mean that the attempt to send data would fail. According to the teachings of the present disclosure, the use of signatures and asynchronous communication between virtual tape complexes may allow the data to be queued and automatically send once an active subsystem is detected.

More specifically, this process occurs when a first subsystem on a first virtual tape complex desires to send data to a second virtual tape complex. For purposes of illustration, the first subsystem may be subsystem 11 and the second virtual tape complex may be tape complex 20. First, subsystem 11 will access control store 16 and determine the signature associated with virtual tape complex 20. In the illustrated embodiment, this would be signature “B.”

Next, subsystem 11 will send the data along with the destination signature “B” to temporary data store 14. As illustrated in FIG. 1, temporary data store 14 is located on virtual tape complex 10 and connected to subsystems 11, 12, and 13. Temporary data store 14 may also be referred to as a “data queue” based on its role in asynchronous communication. Furthermore, the temporary data store 14 may perform various functions, including, but not limited to connecting, saving, closing, or sending. Temporary data store 14 will then copy the data and store it in temporary data store 14.

Temporary data store 14 may then search for virtual tape complexes located on the network that have a signature matching the destination signature. In this example, temporary data store 14 may locate virtual tape complex 20, based on the signature “B.” Temporary data store will then identify if any subsystems are active on virtual tape complex 20. If an active subsystem is detected, then the data will be sent to the subsystem immediately. In particular embodiments, if subsystem 21 is active, the data may be sent to subsystem 21. In alternative embodiments, subsystem 21 may be inactive. However, if another subsystem, such as subsystem 22, is active on virtual tape complex 20, the data will be sent to subsystem 22.

However, if no active subsystems are found with the matching signature, the data will remain in temporary data store 14. Temporary data store 14 will continue monitoring virtual tape complex 20 for subsystems matching the signature to become active. According to particular embodiments, temporary data store 14 will continue monitoring for an available subsystem for a predetermined amount of time. If no subsystem becomes active during this time, temporary data store 14 may generate a notification message. This message may be a communication to the user attempting to send data, and may notify the user that data was unable to be sent between the two virtual tape complexes. In alternative embodiments, the notification message may be an internal system message, which may trigger an automated response by the complex. According to particular embodiments, this may allow the system to automatically investigate why the data was unable to be sent. This predetermined amount of time may be a user-defined value that varies from complex to complex, or it may be a predetermined value for the entire system. According to particular embodiments, this predetermined amount of time may be referred to as a “time to complain.”

According to particular embodiments, if no subsystem becomes active during a predetermined amount of time, temporary data store 14 may cancel the attempt to send data to the second virtual tape complex. This predetermined amount of time may be referred to as a “time to live.” This “time to live” may also be accompanied by a notification message to a user that may notify the user that the attempt to send data has been cancelled. According to particular embodiments, the “time to complain” and “time to live” may be used in the alternative, with only one of these predetermined times used in a system. In alternative embodiments, both the “time to complain” and “time to live” may be used in the same system. In particular embodiments where both predetermined times are used, the “time to live” may be greater than the “time to complain.” The use of both predetermined times together may allow a user or the system to investigate failure to send data between two virtual tape complexes before the attempt is cancelled. However, if the data is unable to be sent before the “time to live” expires, the temporary data store 14 may stop its attempts to send the data. However, if a subsystem matching the signature becomes active before a “time to live” expires, the temporary data store 14 will send the data to that subsystem.

The data transferred between complexes and subsystems may comprise any type of data to be stored or data concerning virtual volume status. In particular embodiments, this data may comprise information comprising scratch status. After data has been written from a virtual volume to actual tape, the data on the virtual volume may be “scratched”—deleted from the cached files, causing the DASD space to be made available for new data.

As mentioned previously, the same virtual volumes may be located on multiple subsystems. Oftentimes, this data is written to actual tape by only one of the subsystems. Therefore, when the virtual volume on that subsystem is scratched, the matching virtual volumes on other subsystems should be similarly scratched. Thus, scratch status may be communicated between the virtual tape complexes. The subsystem that is placed into scratch status may create a message regarding this status, and send it to the temporary data store 14. Temporary data store 14 may then look for subsystems on the network with a matching signature. If any subsystems with matching signatures are found, the temporary data store will send the message to them, after which they may be placed in scratch status.

FIG. 3 represents a flow diagram, represented generally by reference numeral 300, representing some of the processes discussed above. The process starts at step 302, where signatures are generated for each of the virtual tape complexes located on a network. The signatures may comprise a 4 byte CRC32 hash of important information. This information may include, but is not limited to control files and other control information. At step 304, these signatures are stored in the control stores on the respective virtual tape complex.

After signatures have been generated for the virtual tape complexes, communication may be more easily established between various complexes. For instance, at step 306, communication is established between two virtual tape complexes. For example, virtual tape complex 10 and virtual tape complex 20 may establish a communication session. During this session, the two complexes may exchange information, as shown by step 308. This information may include, but is not limited to, the signature corresponding to the virtual tape complex, the subsystems located on the virtual tape complex, and the parameter names of the subsystems. After this information is exchanged, the virtual tape complexes will store, in its own control store, the information about the other virtual tape complex, as shown by step 310.

It should be understood that some of the steps illustrated in FIG. 3 may be combined, modified, or deleted where appropriate, and additional steps may also be added to the flow diagram.

Although the present invention has been described in detail, it should be understood that various changes, substitutions, and alterations can be made without departing from the spirit and scope of the invention as defined by the appended claims.

What is claimed is:

1. A method, comprising:
generating a plurality of signatures, wherein each signature corresponds to and identifies a respective one of a plurality of virtual tape complexes, and wherein each virtual tape complex comprises one or more subsystems and a control store linked to the one or more subsystems; and
for each virtual tape complex, storing a copy of the corresponding signature in the control store corresponding to the virtual tape complex.

2. The method of claim 1, further comprising:
establishing, on a network, communication between first and second virtual tape complexes of the plurality of virtual tape complexes;
between the first and second virtual tape complexes, exchanging signatures corresponding to the respective first or second virtual tape complex and parameter names corresponding to the one or more subsystems located on the respective first or second virtual tape complex;
storing, in the control store of the first virtual tape complex, the signature corresponding to the second virtual tape complex and the parameter names corresponding to the one or more subsystems located on the second virtual tape complex; and
storing, in the control store of the second virtual tape complex, the signature corresponding to the first virtual tape complex and the parameter names corresponding to the one or more subsystems located on the first virtual tape complex.

3. The method of claim 2, wherein establishing communication between first and second virtual tape complexes comprises:
sending, from a first subsystem located on the first virtual tape complex, data and a desired destination signature to a temporary data store located on the first virtual tape complex, wherein the desired destination signature corresponds to the signature corresponding to the second virtual tape complex;
copying the data to the temporary data store; and
monitoring the second virtual tape complex for an active subsystem.

4. The method of claim 3, further comprising sending the data from the temporary data store to the active subsystem when the active subsystem is found.

5. The method of claim 3, further comprising generating a notification message if no active subsystem is found within a predetermined amount of time.

6. The method of claim 3, wherein the data comprises information about scratch status of the first subsystem.

7. A system, comprising:
a plurality of virtual tape complexes, wherein each virtual tape complex comprises one or more subsystems and a control store linked to the one or more subsystems;
for each virtual tape complex, a processor being operable to generate a signature, wherein each signature corresponds to and identifies the respective virtual tape complex;
for each virtual tape complex, the control store being operable to store the complex signature.

8. The system of claim 7, wherein a first and a second virtual tape complexes are operable to:
establish communication between the between the first and second virtual tape complexes of the plurality of virtual tape complexes; and
exchange signatures corresponding to the respective first or second virtual tape complex and parameter names corresponding to the one or more subsystems located on the respective first or second virtual tape complex; and
store, in the control store of the first virtual tape complex, the signature corresponding to the second virtual tape complex and the parameter names corresponding to the one or more subsystems located on the second virtual tape complex; and
store, in the control store of the second virtual tape complex, the signature corresponding to the first virtual tape complex and the parameter names corresponding to the one or more subsystems located on the first virtual tape complex.

9. The system of claim 8, wherein a first subsystem located on the first virtual tape complex is operable to send data and a desired destination signature to a temporary data store located on the first virtual tape complex, wherein the desired destination signature corresponds to the signature of the second virtual tape complex, and wherein the temporary data store comprises a processor operable to:
copy the data; and
monitor the second virtual tape complex for an active subsystem.

10. The system of claim 9, wherein the processor of the temporary data store is further operable to send the data to the active subsystem once the active subsystem is found.

11. The system of claim 9, wherein the processor of the temporary data store is further operable to generate a notification message if no active subsystem is found within a predetermined amount of time.

12. The system of claim 9, wherein the data comprises information about scratch status of the first subsystem.

13. Logic encoded in a computer readable medium and operable, when executed on a processor to:
generate a plurality of signatures, wherein each signature corresponds to and identifies a respective one of a plurality of virtual tape complexes, and wherein each virtual tape complex comprises one or more subsystems and a control store linked to the one or more subsystems; and
for each virtual tape complex, store a copy of the corresponding signature in the control store corresponding to the virtual tape complex.

14. The logic of claim 13, wherein the logic is further operable to:
establish, on a network, communication between first and second virtual tape complexes of the plurality of virtual tape complexes;
between the first and second virtual tape complexes, exchange signatures corresponding to the respective first or second virtual tape complex and parameter names corresponding to the one or more subsystems located on the respective first or second virtual tape complex;
store, in the control store of the first virtual tape complex, the signature corresponding to the second virtual tape complex and the parameter names corresponding to the one or more subsystems located on the second virtual tape complex; and
store, in the control store of the second virtual tape complex, the signature corresponding to the first virtual tape complex and the parameter names corresponding to the one or more subsystems located on the first virtual tape complex.

15. The logic of claim 14, wherein the logic is further operable to:
send, from a first subsystem located on the first virtual tape complex, data and a desired destination signature to a temporary data store located on the first virtual tape complex, wherein the desired destination signature corresponds to the signature of the second virtual tape complex;
copy the data to the temporary data store; and
monitor the second virtual tape complex for an active subsystem.

16. The logic of claim 15, wherein the logic is further operable to send the data from the temporary data store to the active subsystem when the active subsystem is found.

17. The logic of claim 15, wherein the logic is further operable to generate a notification message if no active subsystem is found within a predetermined amount of time.

18. The logic of claim 17, wherein the data comprises information about scratch status of the first subsystem.
